(19) United States
(12) Patent Application Publication
(10) Pub. No.: US 2021/0363718 A1
(43) Pub. Date: Nov. 25, 2021

(54) WATER MANAGEMENT PROTECTIVE MAT DEVICE

(71) Applicant: Donald Loftis, Colorado Springs, CO (US)

(72) Inventor: Donald Loftis, Colorado Springs, CO (US)

(21) Appl. No.: 16/880,991

(22) Filed: May 22, 2020

(51) Int. Cl. E02B 3/12

(52) U.S. Cl. CPC E02B 3/12

(57) ABSTRACT

A water management protective mat device having a protective mat formed by a plurality of weighted tire members interconnected in a grid structure. Each tire member includes a plurality of apertures for receiving one or more rod members. The one or more rod members interconnect a tire member to another tire member. The protective mat is configured to reduce erosion along a stream bank by reinforcing erosion barriers in terrain underneath the protective mat thereby preventing water from eroded the terrain.

### FIELD OF THE INVENTION

Embodiments described herein generally relate to a water management device, and more particularly to a water management protective mat device.

### BACKGROUND OF THE INVENTION

Erosion along a creek bank occurs during rushing waters, such as, heavy rainfall or as the result of increased water flow from adjacent properties due to such activities as construction. Erosion removes soil and rocks from the bank which may result in undercutting and the loss of land along the creek bank. Stabilizing a creek bank is accomplished by natural means, using native plant species to anchor the soil in place. However, erosion reduces the natural barriers formed by the banks and the nutrients within the soil. This results in flooding and reduced biodiversity among plants and animals. Hence, an improved way to reduce or prevent creek erosion is desirable.

### BRIEF DESCRIPTION OF THE DRAWINGS

The various advantages of the embodiments of the present disclosure will become apparent to one skilled in the art by reading the following specification and appended claims, and by referencing the following drawing(s), in which:

FIG. 1A shows an exemplary view of the water management protective mat device according to an embodiment of the present disclosure.

FIG. 1B shows another exemplary view of the water management protective mat device according to an embodiment of the present disclosure.

FIG. 2 shows an exemplary view of a single tire member of the water management protective mat device according to an embodiment of the present disclosure.

### SUMMARY OF THE INVENTION

Exemplary embodiments disclosed herein describe a water management protective mat device having a protective mat formed by a plurality of weighted tire members interconnected in a grid structure. Each tire member includes a plurality of apertures for receiving one or more rod members. The one or more rod members interconnect a tire member to another tire member. The protective mat is configured to reduce erosion along a stream bank by reinforcing erosion barriers in terrain underneath the protective mat thereby preventing water from eroded the terrain.

In some exemplary embodiments, the protective mat is configured to overlay a stream bank region.

In some exemplary embodiments, erosion barriers in terrain include one or more from the group comprising soil, rocks, and plants.

In some exemplary embodiments, each weighted tire member is filled with concrete.

In some exemplary embodiments, the concrete filled tire members of the protective mat prevent water from passing through the protective mat.

In some exemplary embodiments, the weighted tire members of the protective mat are able to withstand the force of water.

In some exemplary embodiments, the size of the protective mat may grow by adding more interconnected weighted tire members.

In some exemplary embodiments, each aperture in a tire member is spaced ninety degrees from one another along the tread of the tire member.

In some exemplary embodiments, each tire member has two rod members inserted therein.

In some exemplary embodiments, one rod member is inserted through apertures located at an east and west positions of tire member respectively.

In some exemplary embodiments, one rod member is inserted through apertures located at a north and south positions of the tire member respectively.

In some exemplary embodiments, the part of the rod member inserted through the apertures located at the east and west positions respectively of the tire member extends outward from the tire member at the east and west positions of the tire member.

In some exemplary embodiments, the part of the rod member inserted through the apertures located at the north and south positions respectively of the tire member extends outward from the tire member at the north and south positions of the tire member.

In some exemplary embodiments, the parts of the rod member extending outward from the tire member at the east and west positions are attached to other rod member parts extending from other tire members.

In some exemplary embodiments, the parts of the rod member extending outward from the tire member at the north and south positions are attached to other rod member parts extending from other tire members.

### DETAILED DESCRIPTION

The present disclosure relates to a water management protective mat device (“the device”). The device operates to reduce erosion of creek and river sides by reinforcing the banks of the riverside so that the natural barriers of the bank, such as, rocks, soil and plants may effectively reduce erosion. The creek bank or river bank is the terrain alongside the bed of a river, creek, or stream. The bank consists of the sides of the channel, between which the flow is confined. The bank is jeopardized when rushing waters occur because the rushing waters tend to uproot or remove the rocks, soil or plants alongside the bank. This may result in erosion of the stream bank, flooding of the land, reduced biodiversity among the plants and animals and loss of land along the creek bank.

The device operates to prevent the removal of the rocks, soil or plants alongside the bank, which thereby reduces the risk of erosion and flooding, biodiversity among the plants and animals and loss of land. The device is configured to overlay a stream bank region. The device is able to withstand the force of water due to the materials the device is made of and the weight of the device. The device includes rubber tires which are filled with concrete. The rubber material and the concrete allow the device to withstand the force of water (e.g., rushing water that may be infused with sediments) without movement. Moreover, the concrete filling ensures that the water will not pass through the device and erode the terrain and any erosion barriers in the terrain, such as, soil, rocks, and plants.

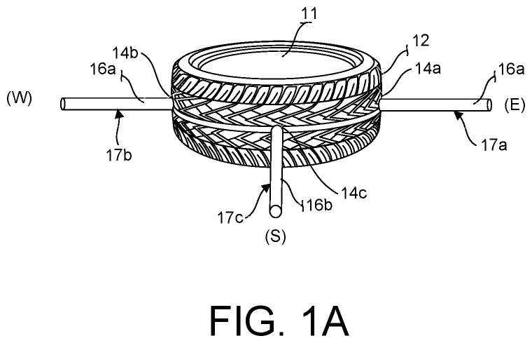

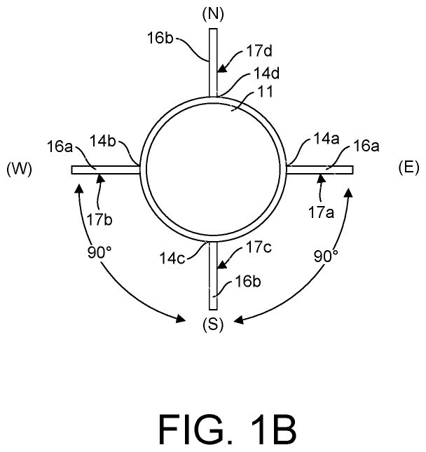

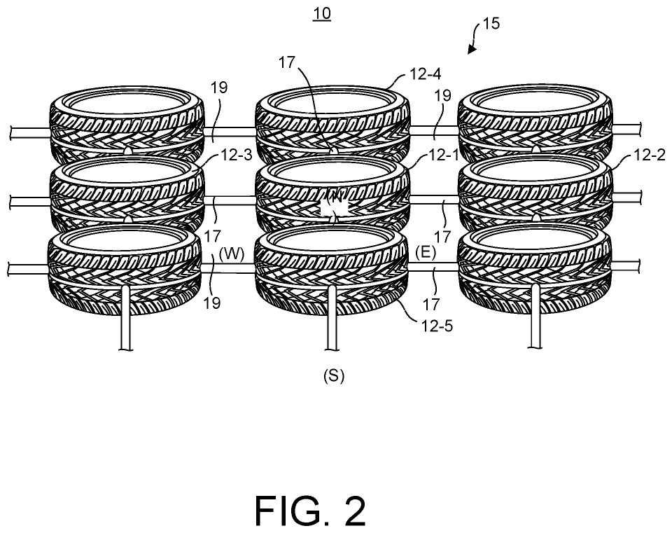

As illustrated in FIGS. 1A, 1B and 2, the device includes a protective mat 10 including a plurality of tire members 12 interconnected in a grid structure 15. Each tire member 12 may be filled with concrete 11 or similar to create weight, and to prevent the tires from filling with water so as to not allow pooling of water in the tire. Each tire member 12 may include a plurality of apertures 14a, 14b, 14c and 14d, and each aperture may be located ninety degrees from one another along the tread of the tire member 12. Each tire member is of the same size and includes two rod members 16a and 16b, such as for example, two metal bars, rebar or similar. The rod members may be longer than the diameter of a tire member by an amount that allows the rod members to be connected together (e.g., welded together).

One rod member, for example, rod member 16a may be connected (i.e., inserted) through apertures 14a and 14b located at east (E) and west (W) positions respectively of rod member 16a with portions 17a and 17b of rod member 16a extending outward from the east (E) and west (W) positions respectively. Likewise, another rod member, for example, rod member 16b may be connected through apertures 14c and 14d located at north (N) and south (S) positions respectively of rod member 16b with portions 17c and 17d of rod member 16b extending outward from the north (N) and south (S) positions. The concrete filled in the tire members 12 fixates the respective rod members inserted in the tire member.

The tire members 12 are interconnected to one another by connection of the rod member 16 portions extending from the east, west, north and south positions forming grid structure 15. A rod member portion, such as, for example, rod member portion 17a located at an east position of a first tire member 12-1 may be connected to another rod member portion, such as, for example, rod member portion 17b located at a west position of a second tire member 12-2. Also, a rod member portion, such as, for example, rod member portion 17b located at a west position of a first tire member 12-1 may be connected to another rod member portion, such as, for example, rod member portion 17a located at an east position of a third tire member 12-3. The respective rod member portions may be welded together as 17 thereby connecting the first tire member 12-1 to the second tire member 12-2 and to the third tire member 12-3.

Likewise, rod member portion 17d located at a north position of a tire member, such as, for example, first time member 12-1 may be connected to a rod member portion 17c located at a south position of a fourth tire member 12-4. Further, rod member portion 17c located at a south position of a tire member, such as, for example, first time member 12-1 may be connected to a rod member portion 17d located at a north position of a fifth tire member 12-5. The respective rod member portions may be welded together as 17 thereby connecting the first tire member 12-1 to the fourth tire member 12-4 and to the fifth tire member 12-5.

The welded rod member portions 17 ensure that a large number of tire members may be easily combined to form the protective mat 10. As such, the size of the protective mat 10 may grow by adding more interconnected weighted tire members.

In operation, the protective mat 10 is placed along a stream bank to protect the underlying terrain. The protective mat reinforces the erosion barriers in the terrain to reduce erosion along the stream bank. The overall weight of the protective mat and the concrete filled tire members 12 prevent water from eroded the terrain as the weight of the protective mat 10 prevents the protective mat from being washed away by rushing water thereby keeping the terrain covered during rushing waters. Moreover, the concrete filled tire members prevent water from passing through the protective mat thereby preventing erosion of the terrain underneath the protective mat.

In another exemplary embodiment, the tire members 12 may be inserted with a metal plate of a size to allow the weighted tire member to be picked up with an electromagnet. This would allow a more automated installation and placement during installation.

Moreover, it should be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.)

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

Those skilled in the art will appreciate from the foregoing description that the broad techniques of the embodiments of the present invention may be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. A water management protective mat device comprising:
a protective mat formed by a plurality of weighted tire members interconnected in a grid structure, each tire member including a plurality of apertures for receiving one or more rod members, the one or more rod members for interconnecting a tire member to another tire member, wherein the protective mat is configured to reduce erosion along a stream bank by reinforcing erosion barriers in terrain underneath the protective mat thereby preventing water from eroded the terrain.

2. The device of claim 1, wherein the protective mat is configured to overlay a stream bank region.

3. The device of claim 1, wherein erosion barriers in terrain include one or more from the group comprising soil, rocks, and plants.

4. The device of claim 1 wherein each weighted tire member is filled with concrete.

5. The device of claim 4, wherein the concrete filled tire members of the protective mat prevent
water from passing through the protective mat.

6. The device of claim 4, wherein the weighted tire members of the protective mat are able to withstand the force of water.

7. The device of claim 1, wherein the size of the protective mat may grow by adding more interconnected weighted tire members.

8. The device of claim 1, wherein each aperture in a tire member is spaced ninety degrees from one another along the tread of the tire member.

9. The device of claim 1, wherein each tire member has two rod members inserted therein.

10. The device of claim 9, wherein one rod member is inserted through apertures located at an east and west positions of tire member respectively.

11. The device of claim 9, wherein one rod member is inserted through apertures located at a north and south positions of the tire member respectively.

12. The device of claim 10, wherein part of the rod member inserted through the apertures located at the east and west positions respectively of the tire member extends outward from the tire member at the east and west positions of the tire member.

13. The device of claim 11, wherein part of the rod member inserted through the apertures located at the north and south positions respectively of the tire member extends outward from the tire member at the north and south positions of the tire member.

14. The device of claim 12, wherein the parts of the rod member extending outward from the tire member at the east and west positions are attached to other rod member parts extending from other tire members.

15. The device of claim 13, wherein the parts of the rod member extending outward from the tire member at the north and south positions are attached to other rod member parts extending from other tire members.
